(19) United States
(12) Patent Application Publication
(10) Pub. No.: US 2026/0273717 A1
(43) Pub. Date: Sep. 17, 2026

(54) POWER TOOL WITH SELF-CLEANING DUST PROTECTION FILTER

(71) Applicant: C. & E. Fein GmbH, Schwaebisch Gmuend-Bargau (DE)

(72) Inventors: Stefan SCHERRENBACHER, Waldstetten (DE); Robert WITTLICH, Durlangen (DE)

(73) Assignee: C. & E. Fein GmbH, Schwaebisch Gmuend-Bargau (DE)

(21) Appl. No.: 19/463,560

(22) Filed: Jan. 29, 2026

(30) Foreign Application Priority Data
Jan. 29, 2025 (EP) 25154681.8

(51) Int. Cl. B25F 5/00; B01D 46/10; B01D 46/40; B24B 23/00

(52) U.S. Cl. CPC B25F 5/008; B01D 46/10; B01D 46/403; B24B 23/00

(57) ABSTRACT

A hand-operated power tool, for example an angle grinder, straight grinder, belt grinder, pipe grinder, fillet weld grinder, band file, or angle polisher, that includes a housing, a drive unit, preferably a motor unit and an electronics unit, which includes at least one waste heat component. The drive unit is arranged in a flow separation housing in an interior space of the hand-operated power tool. The flow separation housing has a housing interior, and an outside air supply chamber is formed by the arrangement of the flow separation housing in the housing of the power tool. The housing interior and the outside air supply chamber being fluidically connected via a flow window that has a dust filter. A cooling air conveying device is situated in the outside air supply chamber and configured to induce a preferably turbulent coolant main flow along the outside air supply chamber.

This nonprovisional application claims priority under 35 U.S.C. § 119(a) to European Patent Application No. 25154681.8, which was filed on Jan. 29, 2025, and which is herein incorporated by reference.

### BACKGROUND OF THE INVENTION

### Field of the Invention

Hand-operated grinding and polishing devices, for example straight grinders, belt grinders, pipe grinders, fillet weld grinders, band files, or angle polishers, are used in numerous applications in industry as well as in the craft trade sector. These power tools have the common feature that when they are used, dust is generated and released by abrasive processes during the grinding or polishing. This represents a risk, since the dust together with the cooling air stream is drawn by the fan of the power tool into the interior of the device, where it may cause damage.

### Description of the Background Art

When dust or other particles deposit on sensitive components, this may result in premature wear or damage to the drive unit or the electronics unit, for example, which may adversely affect the service life and proper functioning of the device.

To avoid such damage, over time various protective measures have been developed. Common approaches include power tools with partially or fully encapsulated drive units which ensure protection of the drive unit. These designs have become the state of the art, and help to reduce penetration of dust. However, a significant disadvantage of this encapsulated design compared to open drive units is the limited heat dissipation, which in turn may reduce the performance of the device. Efficient heat exchange is crucial for trouble-free operation, and may be problematic for encapsulated units.

In addition to encapsulated drive units, there are power tools that are equipped with an external dust protection filter at the motor unit. Such filters in some cases may be removed for cleaning, as described in Patent Specification CN 218397485 U, for example. Although this type of dust protection provides a certain level of protection from the penetration of dust, it also has drawbacks. After a certain operating period, the dust filter becomes clogged with fine grinding or polishing dust, which may hinder the cooling air flow and decrease the cooling power as well as the performance of the drive unit. Cleaning such filters is frequently time-consuming and in practice is therefore often neglected, which impairs the long-term efficiency and durability of the power tool.

CN 21617936 U discloses an angle grinder that uses a filter to clean air flowing into the housing through baffle plates. The filter is situated in a carrier structure with receptacles that are exposed to different frequencies. During operation of the angle grinder, the carrier structure together with the filter oscillates, the intent being to clean the filter by means of the resonance frequency.

A hand-held power tool is known from EP 3 549 717, which corresponds to US 2019/0305640, which is incorporated herein by reference, and in which the air entering the housing is divided into an outer air flow that flows past the motor, and an inner air flow. Situated in front of the motor is a separator disk, which during rotation exerts a radially outwardly acting force on the dust particles contained in the cooling air. The dust particles are thus led into the outer air flow and flow past the motor on the outside. A filter structure is situated in the area of the air inlet to prevent dust particles from entering the housing. The cited publication makes no reference to cleaning of this filter structure.

### SUMMARY OF THE INVENTION

It is therefore an object of the present invention to provide a maintenance-free hand-held power tool having increased user-friendliness.

In an example, the invention relates to a hand-operated power tool, which can be understood to be a portable device that can be manually operated by the user and that is designed for various grinding or polishing operations.

The hand-operated power tool includes a drive unit. The “drive unit” can be understood as a key component of a hand-operated power tool that is responsible for converting electrical energy into mechanical energy. The drive unit typically includes a motor that generates the required power, and an electronics unit that is responsible for controlling and regulating the motor functions. In this context, waste heat components such as cooling elements or fans for dissipating the heat generated by the operation may also be included. The drive unit is crucial for the performance of the tool, and makes a contribution to ensuring the efficiency and durability of the device.

The waste heat component may include various elements or parts that are subject to the dissipation of the heat generated during operation. A “waste heat component” can be understood as a component inside the drive unit of a hand-operated power tool that releases heat during operation and therefore must be actively cooled. Typical waste heat components are parts such as the motor and the electronics unit which generate heat via the conversion of energy. These components require targeted cooling in order to avoid overheating and ensure the optimal functionality and durability of the power tool. Other parts to be cooled may also be provided.

The housing of the drive unit in the form of a flow separation housing includes the drive unit and has a housing interior. The flow separation housing is situated inside the power tool in such a way that an outside air supply chamber is formed between the inner side of the housing of the power tool and the outer side of the flow separation housing.

The housing, which encloses the flow separation housing, in various examples may be partially or completely surrounded by one or more further housings.

It may also be provided that the flow separation housing encloses only the waste heat component, and the drive unit is situated outside the flow separation housing. Therefore, a “flow separation housing” can be understood as a specialized housing inside a hand-operated power tool, whose particular configuration results in an outside air supply chamber. The drive unit, for example, may be situated in the interior of the flow separation housing in addition to other possible components to be cooled. The flow separation housing is thus used to control and separate flows within the power tool to enable targeted cooling of the waste heat component.

The above-mentioned flows may include fluids of any type, in particular gaseous fluids such as air or air mixtures, which may also be referred to below as “coolant.”

The interior of the flow separation housing and the outside air supply chamber are fluidically connected to one another via a flow window. The separation of the cooling air brought about by the flow separation housing ensures that only filtered air passes into the housing interior, and prevents dust and other contaminants from penetrating into the sensitive components of the drive unit.

“Flow window” can be understood as an opening in the flow separation housing that connects the housing interior and the outside air supply chamber. The flow window is equipped with a dust filter for the filtering, thus preventing penetration of dust and particles, regardless of their size, into the housing interior. The flow window allows a targeted auxiliary flow of filtered cooling air to pass into the housing interior in order to effectively cool the waste heat components, while the main air flow is led along the outside air supply chamber.

“Dust filter” can be understood as a filter element that is situated in the flow window of the flow separation housing of a hand-operated power tool. The dust filter prevents abrasive particles and contaminants from the outside air supply chamber from passing into the housing interior, while at the same time a filtered auxiliary flow of the cooling air stream is able to pass through. The dust filter is positioned in such a way that its filter surface is tangential to the flow direction of the coolant main flow. This ensures that particles are efficiently held back and do not collect on the filter, but instead are transported away by the coolant main flow, which ensures a longer filter service life and constant cooling power.

In addition, the hand-operated power tool includes a cooling air conveying device that is situated in the outside air supply chamber of the power tool and configured to generate a coolant main flow which flows around the flow separation housing and is used for the external cooling of the flow separation housing, and at the same time for discharging dust. “Cooling air conveying device” can be understood as a component in the outside air supply chamber of a hand-operated power tool that is configured to generate an air flow and to lead it in a targeted manner through the interior of the tool along the outside air supply chamber. This device may be designed as a fan, a blower, or some other air-conveying element. It induces a coolant main flow that is preferably turbulent and flows around the flow separation housing.

In turn, it is possible that from this preferably turbulent coolant main flow a filtered coolant auxiliary flow may be branched off which passes through the flow window and into the housing interior, where it cools the waste heat component in a targeted manner. This ensures efficient cooling, while at the same time the housing interior remains protected from dust and particles. The filter surface of the dust filter is designed in such a way that it efficiently filters the coolant main flow.

The hand-operated power tool preferably also includes a pumping device that is situated at least partially in the housing interior. The pumping device, also referred to as a pump, is configured to generate a negative pressure in the housing interior relative to the housing exterior in order to draw in the filtered coolant auxiliary flow, which is branched off from the coolant main flow, through the flow window, transversely to the flow direction of the coolant main flow.

A “pumping device” can be understood as a component which generates a negative pressure, and which is preferably situated in the housing interior of a hand-operated power tool. The pump is preferably configured in such a way that it generates a negative pressure in the housing interior in comparison to the outside air supply chamber. This negative pressure is used to draw in the filtered coolant auxiliary flow, which is branched off from the main flow, through the flow window, transversely to the flow direction of the coolant main flow. In this way the pump assists with the targeted flow of the coolant through the interior, which enables effective cooling of the waste heat components inside the housing.

The hand-operated power tool preferably also includes a drive shaft, and the cooling air conveying device is coupled to the drive shaft.

A “drive shaft” can be understood as a rotating element that is an integral part of the cooling air conveying device of a hand-operated power tool. The drive shaft is designed in such a way that it is coupled to the cooling air conveying device, which enables it to generate a coolant main flow and to actively lead it along the outside air supply chamber. The rotation of the drive shaft induces a turbulent coolant main flow which, due to the branching off of a filtered coolant auxiliary flow, contributes to the effective cooling of the waste heat components. The coupling of the drive shaft to the cooling air conveying device allows a synchronized, efficient air flow which assists with constant, targeted cooling of the drive unit.

The pumping device or pump can be preferably a rotatable component, in particular having a disk shape or cylindrical shape, that is situated in a cylindrical opening in the flow separation housing and that closes the opening, with a conveying structure, in particular a comb disk having a spiral depression at the outer side of the comb disk extending in the circumferential direction.

The pumping device can have a spiral depression at a cylindrical circumference. The pumping device is preferably coupled to the rotor of the drive shaft and driven by same.

“Spiral depression” can be understood as a specialized structure that is situated at a cylindrical circumference. This depression has a spiral or helical design, and makes a contribution to optimizing the air or coolant flow within the flow separation housing. The spiral depression allows a controlled conveying capacity and targeted guiding of the air flow.

Since the pump can be coupled to the drive shaft, the spiral depression is actively incorporated into the rotational movement of the drive shaft. As a result of this coupling, a negative pressure is generated which draws in the filtered coolant auxiliary flow, thus bringing about cooling of the waste heat components inside the housing of the power tool, which makes a contribution to the optimal performance and durability of the device.

The pumping device can have a left-hand thread groove with a pitch in the range of 1.5 mm to 3.5 mm, preferably in the range of 2.0 mm to 2.5 mm.

A gap, can be in the range of 0.2 mm to 1.0 mm, particularly preferably in the range of 0.4 mm to 0.6 mm, is preferably present between the outer diameter of the cylindrical circumference of the pumping device and the inner diameter of the housing interior in the area of the pumping device.

The flow separation housing can include a motor cover, and the flow window is situated at a circumferential surface of the motor cover.

“Motor cover” can be understood as a protective device that at least partially covers the flow separation housing of a hand-operated power tool and in particular protects the motor of the drive unit. The motor cover is used to protect the motor from external influences such as dust, dirt, and mechanical damage, thus promoting the durability and functionality of the motor.

The motor cover can have at least one flow window situated at a circumferential surface of the motor cover. This flow window allows a fluidic connection between the housing interior and the outside air supply chamber. Air flow can pass from the outside air supply chamber, through the flow window, and into the housing interior. The arrangement of the flow window at the motor cover ensures that the filtered coolant auxiliary flow can be effectively led through the motor cover to allow targeted cooling of the motor, and at the same time to minimize the penetration of dust and contaminants into the interior of the flow separation housing. This contributes to the efficient cooling and optimal performance of the hand-operated power tool. In various embodiments, the flow windows may also be situated at a circumferential surface of the flow separation housing.

The flow window can be a plurality of flow windows, the plurality of flow windows preferably being arranged equidistantly.

“Plurality of flow windows” can be understood as multiple openings in the flow separation housing and/or the motor cover which allow fluidic connections between the housing interior and the outside air supply chamber. This plurality of flow windows is preferably arranged in such a way that the flow windows are equidistantly spaced from one another, which means that they are uniformly spaced apart.

The arrangement of a plurality of flow windows promotes improved air flow, and allows a uniform distribution of the filtered coolant auxiliary flow in the flow separation housing. This results in more effective cooling of the waste heat components and improves the performance of the hand-operated power tool. In addition, the equidistant spacing ensures that all areas of the motor or of the drive unit are uniformly ventilated and cooled, which further increases the efficiency of the cooling and minimizes the risk of overheating.

The dust filter and/or the pump can include at least one of the following materials: metal, sintered metal, ceramic, sintered ceramic, polymer, nonmagnetic material, and/or stainless steel.

The dust filter as well as the pump may thus be made up of a plurality of materials that may be used to ensure optimal performance and durability. These include metal, which is frequently used due to its high strength and stability as well as its ability to withstand high temperatures. A specialized form is sintered metal, which is produced via the sintering process. It provides a porous structure that allows effective filtration and improved air flow, thus increasing the efficiency of the dust filter.

Ceramic is another important material that is produced by heating and cooling of inorganic components. It is hard, wear-resistant, and provides high temperature resistance, which makes it ideal for applications with high thermal loads. Its behavior is similar to sintered ceramic, which is likewise produced by sintering and additionally has chemical resistance, which makes it suitable for use in dusty and humid environments.

Polymers provide a cost-effective, flexible alternative, since they are lightweight and chemically resistant. Their versatility allows them to be processed in various forms, which makes them ideal for seals and flexible applications. In addition, nonmagnetic materials are used to ensure that the performance of the power tool is not impaired by electromagnetic interferences. This contributes to the reliability and stability of the device.

Stainless steel provides a high level of corrosion protection, and has high robustness. When it contains at least 10.5% chromium, it offers excellent resistance to rust, and is thus particularly suitable for use in demanding environments. Use of these materials in the dust filter and in the pump makes a contribution to significantly increasing the efficiency and durability of the hand-operated power tool.

The dust filter can be designed as a filter cloth.

A “filter cloth” can be understood as a specialized, permeable woven fabric that is designed for filtering dust and other particles. It is made up of fibers that are arranged in such a way that they provide a large surface that is capable of holding back particles from the air or the coolant flow, while at the same time allowing flow of air or liquid.

The use of a filter cloth as a dust filter provides several advantages. First, a filter cloth is characterized by its flexibility and adaptability, which allows simple integration into the design of the power tool. Furthermore, the filter cloth may be manufactured in various densities and material combinations to meet the specific requirements for the filtration, which ensures a high level of adaptability to different operating conditions. A further advantage is the good air permeability, which promotes effective air flow and at the same time enables efficient dust filtration.

The dust filter can be designed as a screen cloth and/or screen plate.

A “screen cloth” can be understood as a fine-meshed material that is made up of interwoven wires or threads and used for filtering dust and other particles. This woven fabric allows small particles to be held back while permitting air or liquids to flow through the mesh.

A “screen plate” can be understood as a flat metal plate that is provided with a plurality of holes in order to perform a similar function as the screen cloth. Alternatively, a screen plate may be formed by an expanded metal or by a plate that is provided with baffle-like openings. Screen plates may have differently shaped openings having various hole sizes and elevations that are selected corresponding to the specific requirements for the filtration.

The use of a screen cloth and/or screen plate as a dust filter offers several advantages. First, the screen allows effective separation of dust and other unwanted particles, while at the same time the air or liquid flow is maintained. Second, the screen cloth and screen plate are extremely robust and durable. Furthermore, the structure of the screens allows a high throughput rate, which assists with the efficiency of the cooling process in the power tool and reduces the risk of overheating.

The dust filter, as an edge filter, is preferably made from a wound metal wire.

“Edge filter” can be understood as a specialized type of filter that is made from wound metal wire. This type of filter is designed in such a way that, due to narrow gaps or spaces that result from the winding of the wire, it allows air or coolant to pass through, while at the same time it holds back larger particles such as dust and dirt. The structure of the edge filters allows effective separation of unwanted particles and contaminants.

Use of an edge filter made from wound metal wire as a dust filter offers several advantages. First, the metal wire is characterized by high strength and durability, which ensures a long service life of the filter, even under difficult operating conditions. Second, the wound structure provides an enlarged filter surface, which improves the efficiency of the dust removal and at the same time does not limit the air or liquid flow. Furthermore, the metal wire may have various cross-sectional shapes (round, trapezoidal, rectangular, or square, with and without edges), thus enabling the formation of an edge filter that meets the desired requirements. Use of an edge filter thus contributes to optimizing the performance of the hand-operated power tool by minimizing the accumulation of dust and contaminants and maintaining an effective coolant flow.

The dust filter is preferably calendered at the surface.

“Calendered dust filter” can be understood to mean that the filter material (filter cloth, filter fabric) has been processed using a calendering process in which the filter material is led between two rotating rollers. This process results in compaction and smoothing of the surface structure of the filter, so that the pores and meshes of the material become more uniform and controlled. This improves the filtration properties of the filter by optimizing the permeability for air or coolant, and at the same time maximizing the retention of dust and other particles.

Use of a calendered dust filter offers several advantages. First, the calendering process improves the structural integrity of the filter, resulting in a longer service life and resistance to mechanical stresses. Second, the calendered filter can achieve a more uniform filtering effect, which means that it is able to hold back particles more efficiently without significantly hindering the air or liquid flow. Furthermore, the smooth surface of the calendered filter facilitates cleaning, since less dirt and deposits are able to accumulate. This contributes to increasing the efficiency of the cooling process. Overall, a calendered dust filter significantly improves the performance of the power tool by minimizing the accumulation of dust and ensuring an optimal air or coolant flow.

The hand-operated power tool preferably has a cooling air inlet and a cooling air outlet.

“Cooling air inlet” can be understood as a specially designed opening or channel in the hand-operated power tool through which air or coolant can enter the device.

“Cooling air outlet” can be understood as a further opening or channel that allows the heated air flow to leave the power tool. Both openings, the inlet opening and the outlet opening, are shaped and arranged in such a way that they promote turbulent air flow and maximize the cooling air supply and the heat dissipation, respectively.

Integration of a cooling air inlet and a cooling air outlet into the hand-operated power tool allows a continuous flow of air, which contributes to keeping the temperature of the drive unit low and preventing overheating. This is particularly important, since an excessively high temperature can impair the performance of the tool and result in defects in the tool.

In addition, the combination of a cooling air inlet and a cooling air outlet improves the efficiency of the cooling system by providing a targeted air flow that effectively discharges the waste heat. This not only results in better performance of the power tool, but also makes a contribution to the durability of the drive unit.

Furthermore, dust and other particles that are generated during operation can be discharged through the cooling air outlet, which minimizes the accumulation of contaminants inside the tool. These design features are thus critical for optimal functioning and ease of maintenance of the hand-operated power tool.

Turbulent flow of the turbulent coolant main flow and the shear forces that form preferably bring about self-cleaning of the dust filter.

“Turbulent flow” can be understood to mean that the coolant main flow in the hand-operated power tool is designed in such a way that there is chaotic, irregular motion within the coolant main flow, and the motion of the coolant main flow is not laminar. As a result of this turbulent flow, the air particles within the coolant main flow undergo flow in various directions, which increases the efficiency of the heat transfer process and ensures more uniform cooling of the drive unit. Air flows as a rule have turbulent processes. Turbulent flows occur with high Reynolds numbers that are typical for most practical applications with air, as well as for the cooling air of a power tool.

The turbulent flow also generates shear forces within the coolant main flow. These forces result from the different velocities and directions of motion of the air particles in the flow. These shear forces act directly on the surface of the dust filter, and cause accumulated dust and contaminants to be released from the filter surface and returned to the coolant main flow instead of being deposited on the filter surface.

The occurrence of turbulent flow which generates shear forces offers several advantages for the dust filter. First, the need for frequent manual cleaning is reduced, since the shear forces ensure that little or no dust and deposits accumulate. This results in a longer service life of the filter and reduces maintenance costs.

Second, this self-cleaning property improves the overall efficiency of the cooling system. A clean dust filter ensures that the coolant auxiliary flow can pass through unhindered, thus optimizing the cooling power and reducing the risk of overheating of the drive unit.

As a whole, the turbulent flow and the resulting shear forces make a significant contribution to the functionality and durability of the hand-operated power tool by ensuring effective cooling and continuous self-cleaning of the dust filter.

The at least one waste heat component preferably includes at least one of the following components or a portion thereof: drive unit, motor unit, and electronics unit.

Due to a targeted flow of cooling air, the invention thus ensures efficient cooling of the waste heat component, thereby avoiding overheating and increasing the performance and service life of the power tool. The design of the dust filter transverse to the flow direction of the coolant main flow minimizes the accumulation of dust and contaminants inside the tool, which reduces the need for frequent cleaning. In addition, due to the turbulent flow the self-cleaning mechanism allows continuous removal of dust, thus lowering maintenance costs. Furthermore, robust materials such as metal, sintered metal, and stainless steel ensure a long service life of the components, even under demanding operating conditions. Lastly, minimizing the accumulation of dust, and the effective cooling, increase the overall performance of the power tool.

Overall, the invention represents a significant improvement in the design and functionality of hand-operated power tools by combining efficient cooling and effective dust control, resulting in greater reliability and a higher level of user satisfaction.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a cross section of the hand-operated power tool according to an example of the invention;

FIG. 2 shows a cross section of a partial area of the power tool according to FIG. 1, from which the flow separation housing is apparent;

FIG. 3 shows the flow separation housing 4 as a central component in the hand-operated power tool 1, in a perspective view;

FIG. 4 shows the perspective view of a motor cover of the hand-operated power tool from FIG. 1;

FIG. 5 shows the perspective view of a pump in the form of a comb disk of the hand-operated power tool from FIG. 1; and

FIG. 6 shows the filtering principle used for generating the filtered coolant auxiliary flow of the hand-operated power tool from FIG. 1.

### DETAILED DESCRIPTION

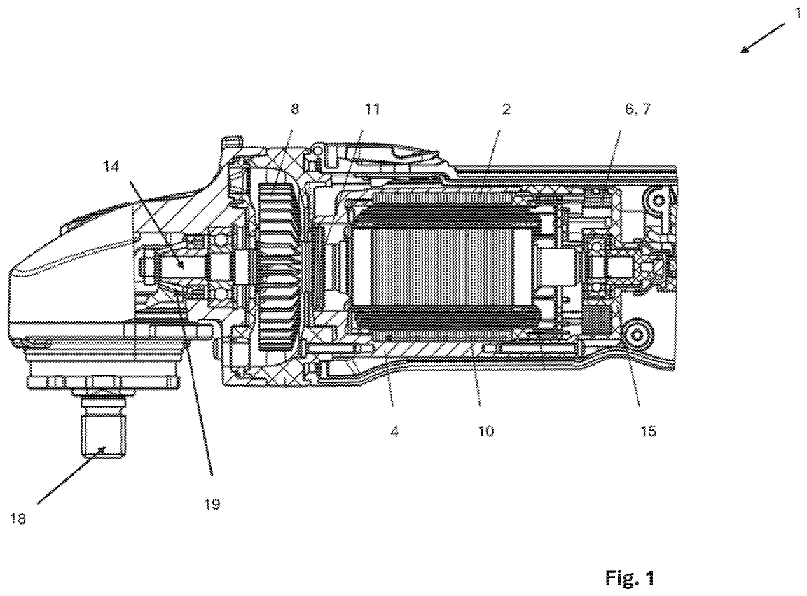

FIG. 1 shows the hand-operated power tool 1, which is designed in particular for grinding and polishing operations such as with angle grinders, straight grinders, belt grinders, pipe grinders, fillet weld grinders, band files, or angle polishers.

This power tool 1 contains a central drive unit 2, which includes a motor unit and an electronics unit and which sets a drive shaft 14 into rotational motion. A pump 11 and a cooling air conveying device 8 are connected to the drive unit 2. The pump 11 and the cooling air conveying device 8 are connected to the drive shaft 14, and rotate with it in the same direction. Present between the drive shaft 14 and an output shaft 18, situated at an approximately 90°angle with respect to the drive shaft 14, is an angular gear 19 that converts the drive movement in the longitudinal direction of the power tool into an output movement transverse to the longitudinal direction. A tool can be situated at the output shaft 18.

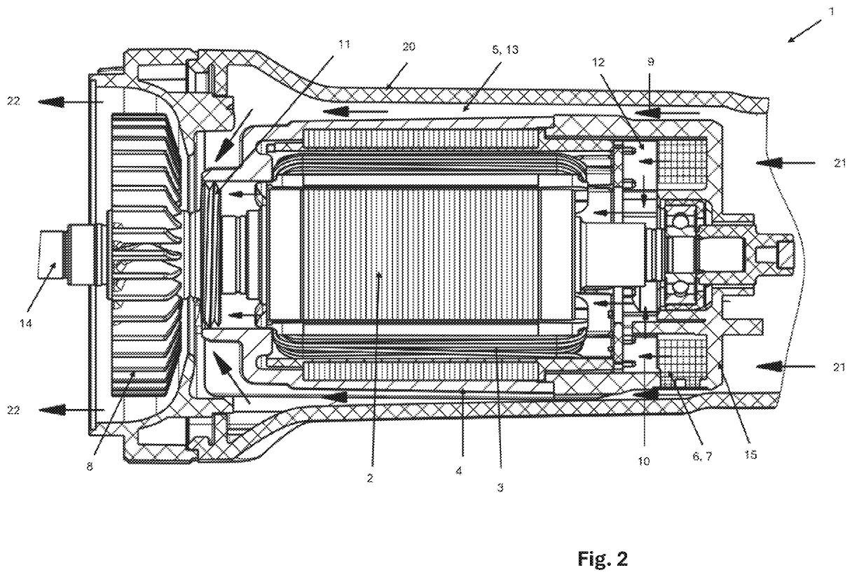

FIG. 2 shows a partial area of the power tool 1, from which the perspective view of a flow separation housing 4 is apparent. The flow separation housing 4 is situated inside the housing 20 of the power tool 1. The flow separation housing 4 contains a drive unit 2 which includes at least one waste heat component 3, in the present case the motor unit. During operation, the motor unit generates heat which must be cooled in order to maintain the service life and performance of the tool.

The flow separation housing 4, in the present case a drive unit housing 4, is positioned inside the housing 20 of the power tool 1, forming an interior space 5 between the inner side of the housing 20 and the outer side of the flow separation housing 4. In other words, the outer side of the flow separation housing 4 is spaced apart from the inner side of the housing 20 of the power tool 1. The interior space 5 or the outside air supply chamber 13 is formed by this arrangement. The flow separation housing 4 is designed in such a way that it has a housing interior 12 that is fluidically connected to the outside air supply chamber 13 via a flow window 6. This flow window 6 is equipped with a dust filter 7 which prevents abrasive particles, formed during operation, from entering the housing interior 12. The dust filter 7 protects the motor unit from wear, thus ensuring a prolonged service life and reliability of the power tool 1.

For optimal cooling of the power tool 1, a cooling air conveying device 8 that generates a cooling air flow is installed in the outside air supply chamber 13. This cooling air conveying device 8 ensures a turbulent coolant main flow 9 along the outside air supply chamber 13.

The arrangement of the filter surface of the dust filter 7 is tangential to the flow direction of this coolant main flow 9, as a result of which the dust particles are blown directly off the filter 7, thus assisting with self-cleaning. This tangential arrangement of the filter surface of the dust filter 7 with respect to the flow direction of the coolant main flow 9 ensures effective filtration and reduces the risk of blockage due to dust particles. The coolant main flow 9 is led in a targeted manner by the flow control, which contributes to the continuing long-term performance of the dust filter.

A portion of the air flow, the filtered coolant auxiliary flow 10, is branched off from the coolant main flow 9 in order to pass into the housing interior 12 and cool the waste heat component 3, present there, in a targeted manner. This allows controlled temperature regulation and prevents overheating of the motor. Dust is prevented from being able to penetrate into the sensitive areas of the drive unit 2.

In the exemplary embodiment shown, the power tool 1 also includes a pumping device (also referred to as a pump) 11 which is provided in the housing interior 12. This pump 11 generates a negative pressure inside the housing in order to draw in the filtered coolant auxiliary flow 10. The filtered auxiliary flow 10 is drawn in through the flow window 6, transversely to the flow direction of the main flow 9, which further increases the efficiency of the cooling.

The drive shaft 14 of the power tool 1 is coupled to the cooling air conveying device 8. This coupling allows the air flow to be efficiently controlled, and allows the discharge of excess heat to be actively assisted. To bring about the conveying of air, the pump 11, which likewise is connected to the drive shaft 14, has a spiral depression at its cylindrical circumference. This shape-imparting design at the circumference assists with drawing in the air flow from the housing interior 12 of the flow separation housing 4. The combination of the cooling air conveying device 8 with the pump 11 generates a suction effect when the cooling air conveying device and the pump are set into rotational motion. A portion is thus branched off from the coolant main flow 9, and passes into the housing interior 12 of the flow separation housing 4 via the flow window 8 and the dust filter 7. The drive unit 2 may be effectively cooled by this portion, the filtered coolant auxiliary flow 10.

To efficiently control the air flow and achieve uniform distribution of the cooling, the flow separation housing 4 is equipped with a motor cover 15, with the flow window 6 being positioned at the circumferential surface of the motor cover 15. In addition, the flow window 6 is designed as a plurality of equidistantly spaced openings. This arrangement assists with uniform distribution of the air flow and contributes to the self-cleaning of the filter 7, since the turbulent flow and the resulting shear forces reduce, and in the ideal case prevent, the accumulation of dust on the filter 7. Furthermore, the hand-operated power tool 1 has a cooling air inlet 21 and a cooling air outlet 22 through which air can respectively enter and exit the power tool 1. These openings are strategically positioned to ensure an effective air flow of the cooling air stream and to discharge the waste heat of the drive unit 2.

Combining these elements provides a durable power tool 1 with increased performance that is protected from damage due to abrasive dust and that ensures efficient cooling of the important components.

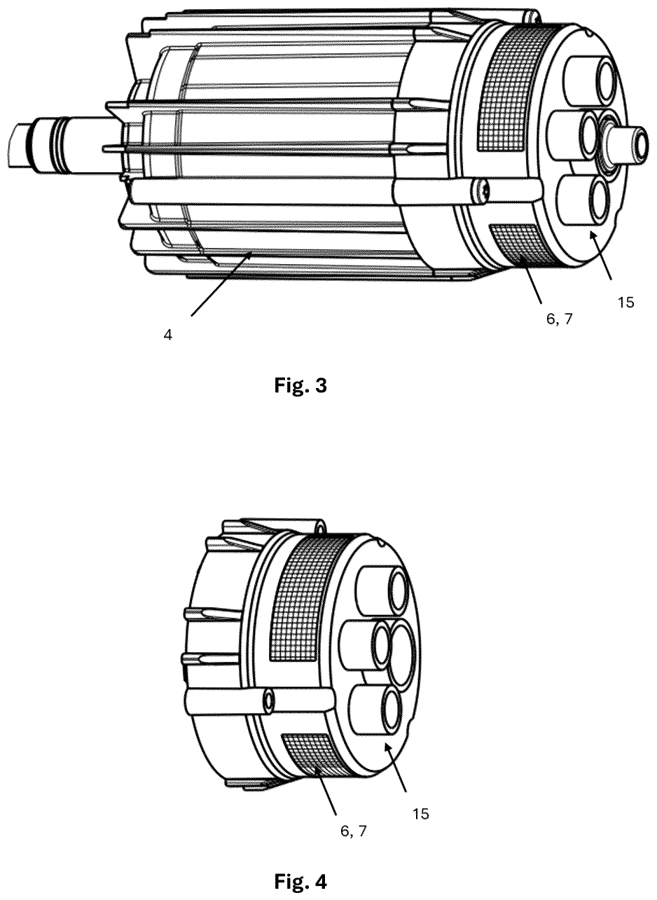

FIG. 3 shows a perspective view of the flow separation housing 4 as a central component in the hand-operated power tool 1 which encloses and protects the drive unit 2, in particular the motor unit. The closed outer shape of the flow separation housing 4 results in a distinct separation between the housing interior 12, in which the sensitive components of the drive unit 2 are present and in which the filtered coolant auxiliary flow 10 may be branched off via the flow windows 6, and the outside air supply chamber 13 through which the turbulent coolant main flow 9 passes.

The flow separation housing 4 is designed in such a way that it fluidically connects the housing interior 12 and the outside air supply chamber 13 via the flow window 6 with an integrated dust filter 7. The flow window 6 is strategically positioned to allow targeted guiding of the filtered coolant auxiliary flow 10 into the housing interior 12. The housing interior 12 thus remains largely free of dust particles, while the coolant auxiliary flow 10 gains access to the waste heat components in order to ensure cooling thereof.

In summary, the flow separation housing 4 is used as a protective, guiding structure that allows efficient cooling of the drive unit, and at the same time prevents abrasive particles from penetrating into sensitive components. This improves the durability and reliability of the power tool 1 by use of an encapsulated yet well-ventilated system.

FIG. 4 shows the motor cover 15 as an integral part of the flow separation housing 4. The motor cover contributes to the stability and security of the drive unit 2 by shielding it from external influences such as dust, dirt, and other contaminants.

The motor cover 15 is designed in such a way that it has a plurality of equidistant flow windows 6 at its circumferential surface. These flow windows 6 allow the controlled passage of the coolant auxiliary flow 10, which through the flow separation housing 4 with the pump 11 and the cooling air conveying device 8 situated therein branches off from the coolant main flow 9 and is cleaned by the dust filter 7 before it flows into the housing interior 12. Due to this arrangement, the motor cover 15 actively assists with the air flow and ensures that only filtered air passes into the vicinity of the waste heat component 3.

Overall, the motor cover 15 performs the double function of protecting the waste heat component 3 and assisting with effective cooling thereof, which contributes to increased performance and durability of the power tool 1.

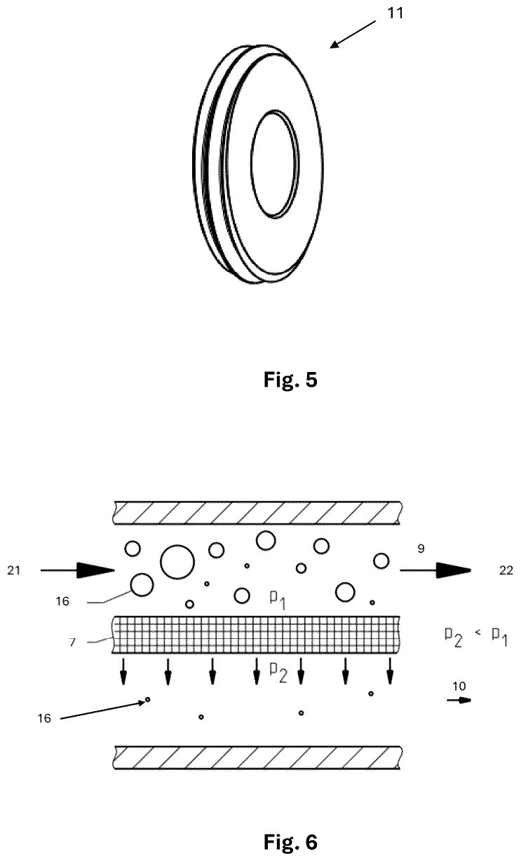

FIG. 5 shows the pumping device 11, which in the shown embodiment is designed as a comb disk 11 with a spiral depression at its cylindrical circumference and is directly coupled to the drive shaft 14 of the hand-operated power tool 1. This design ensures efficient conveyance of air and generation of negative pressure in order to draw in the coolant auxiliary flow 10 in a targeted manner. Due to the spiral depression along the comb disk, a continuous negative pressure is generated in the housing interior 12 which acts relative to the outside air supply chamber 13.

This negative pressure assists with drawing in the filtered coolant auxiliary flow 10 transversely to the flow direction of the coolant main flow 9 by leading the air through the flow window 6 and the dust filter 7 attached thereto. The spiral design of the depression provides a targeted, uniform flow which ensures constant cooling of the waste heat component 3 of the drive unit 2.

The comb disk 11, with its specialized shape, generates a constant negative pressure in the flow separation housing 4, thus ensuring reliable separation of the coolant auxiliary flow 10 from the coolant main flow 9. The coolant auxiliary flow 10 that is cleaned by the dust filter results in clean, controlled cooling of the sensitive motor components.

FIG. 6 shows the filtering principle of the hand-operated power tool 1. The coolant main flow 9 flows tangentially across the dust filter 7 with a turbulent motion at high velocity. Due to this arrangement, large particles in the coolant main flow 9 are led along the surface of the dust filter 7, so that they flow within the outside air supply chamber 13 in the direction of the cooling air outlet 22 without passing into the housing interior 12.

Due to the negative pressure (p2<p1) that is present in the housing interior 12, a filtered coolant auxiliary flow 10 is branched off and used in a targeted manner for cooling the waste heat components 3.

The turbulent flow of the main flow 9 ensures that particles do not adhere to the filter surface, but instead are continuously carried away. The filtering function thus always remains active without limitation, which significantly improves the service life and performance of the dust filter 7 and thus of the power tool 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A hand-operated power tool comprising:
a housing;
a drive unit or a motor unit;
an electronics unit that includes at least one waste heat component, the drive unit being arranged in a flow separation housing in an interior space of the hand-operated power tool, the flow separation housing having a housing interior;
an outside air supply chamber formed by the arrangement of the flow separation housing in the housing of the power tool, the housing interior and the outside air supply chamber being fluidically connected via a flow window that has a dust filter;
a cooling air conveying device arranged in the outside air supply chamber and configured to induce a turbulent coolant main flow along the outside air supply chamber;
a filter surface of the dust filter arranged tangentially to the flow direction of the coolant main flow; and
a filtered coolant auxiliary flow configured to cool the at least one waste heat component and adapted to be branched off via the dust filter.

2. The hand-operated power tool according to claim 1, further comprising a pump that is at least partially arranged in the housing interior, the pump being configured to induce a negative pressure in the housing interior relative to the outside air supply chamber in order to draw in the filtered coolant auxiliary flow that branches off from the coolant main flow through the flow window and transversely to the flow direction of the coolant main flow.

3. The hand-operated power tool according to claim 1, further comprising a drive shaft, wherein the cooling air conveying device is coupled to the drive shaft.

4. The hand-operated power tool according to claim 2, wherein the pump has a spiral depression at a cylindrical circumference and is coupled to the drive shaft.

5. The hand-operated power tool according to claim 2, wherein the pump has a left-hand thread groove with a pitch in the range of 1.5 mm to 3.5 mm or in the range of 2.0 mm to 2.5 mm.

6. The hand-operated power tool according to claim 2, wherein the power tool has a gap or in the range of 0.2 mm to 1.0 mm or in the range of 0.4 mm to 0.6 mm between an outer diameter of the cylindrical circumference of the pump and an inner diameter of the housing interior in an area of the pump.

7. The hand-operated power tool according to claim 1, wherein the flow separation housing includes a motor cover, and wherein the flow window is arranged at a circumferential surface of the motor cover.

8. The hand-operated power tool according to claim 1, wherein the flow window is formed of a plurality of flow windows, wherein the plurality of flow windows are arranged equidistantly.

9. The hand-operated power tool according to claim 2, wherein the dust filter and/or the pump are formed of at least one of the following materials: metal, sintered metal, ceramic, sintered ceramic, polymer, nonmagnetic material, and/or stainless steel.

10. The hand-operated power tool according to claim 1, wherein the dust filter is designed either as: a filter cloth, a screen cloth and/or screen plate, an edge filter made from a wound metal wire, or is calendered at the surface.

11. The hand-operated power tool according to claim 1, further comprising a cooling air inlet and a cooling air outlet.

12. The hand-operated power tool according to claim 1, wherein a turbulent flow of the coolant main flow and shear forces that form bring about self-cleaning of the dust filter.

13. The hand-operated power tool according to claim 1, wherein the at least one waste heat component includes at least one of the following components or a portion thereof: drive unit, motor unit, and/or electronics unit.

14. The hand-operated power tool according to claim 1, wherein the flow separation housing is a drive unit housing, a motor unit housing, and/or an electronics unit housing.

15. The hand-operated power tool according to claim 1, wherein the hand-operated power tool is an angle grinder, straight grinder, belt grinder, pipe grinder, fillet weld grinder, band file, or angle polisher.
